(19) United States
(12) Patent Application Publication
(10) Pub. No.: US 2026/0109489 A1
(43) Pub. Date: Apr. 23, 2026

(54) SPACECRAFT-BASED DEPLOYABLE SOLAR CONCENTRATOR FOR GASIFYING CRYOGENIC LIQUIDS

(71) Applicant: Blue Origin, LLC, Kent, WA (US)

(72) Inventor: Brian Kulwik, Seattle, WA (US)

(21) Appl. No.: 18/924,909

(22) Filed: Oct. 23, 2024

(51) Int. Cl. B64G 1/66; B64G 1/44; F24S 20/20; F24S 20/55; F24S 23/74

(52) U.S. Cl. CPC B64G 1/66; B64G 1/443; F24S 20/20; F24S 20/55; F24S 23/745

(57) ABSTRACT

A solar collector system that is storable and deployable on a space vehicle is disclosed. Such a system may be used for generating electricity from solar energy or for collecting heat for converting a cryogenic liquid to its gas phase. The solar collector system may include a reflective solar collector membrane, an attachment to connect portions of the reflective solar collector membrane to the space vehicle, and a winch and tether system on the space vehicle for holding the reflective solar collector membrane in a closed state that wraps around the space vehicle or for holding the reflective solar collector membrane in a parabolic cylindrical shape in an open state. In the closed state, the reflective solar collector membrane may be configured to insulate the space vehicle from solar radiation.

### BACKGROUND

Gaseous reactants, propellants, and utility gases like gaseous oxygen and hydrogen are used for a variety of functions in a space vehicle. Because oxygen and hydrogen are most often stored as cryogenic liquids, a liquid-gas conversion system would be useful. Such conversion systems may operate using a combustion-or pneumatically-driven pump with a burner and a heat exchanger. This type of operation, which could present energy consumption and reliability concerns, may likely consume reactants (e.g., a fuel and an oxidizer) and likely involve parasitic fluid loss from various cryogenic purges and chill-down operations. In addition, operations in low-gravity require special attention to the behavior and dynamics of liquid and gas phases of the cryogenic liquids (e.g., propellants). Thus, demand continues for a reliable liquid-gas conversion system that has relatively low mass, energy efficiency, and simple manufacturability, while being operable in the confines and limited resources involved in space flight or other space missions.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic flow diagram of a solar gasification system, according to some embodiments.

FIG. 2 is a schematic diagram of a heat exchange portion of a solar gasification system, according to some embodiments.

FIG. 3 is a schematic diagram of a heat exchange portion of a solar gasification system, according to some other embodiments.

FIG. 4 is a schematic diagram of a reflective solar collector membrane that is undeployed and wrapped around a space vehicle, according to some embodiments.

FIG. 5 is a schematic diagram of a reflective solar collector membrane that is deployed into a parabolic cylinder on a single side of a space vehicle, according to some embodiments.

FIG. 6 is a schematic side view of a rocket that includes a fairing that encloses a space vehicle and a solar collector system, according to some embodiments.

FIG. 7 is a closeup schematic side view of the fairing that encloses the space vehicle and the solar collector system, according to some embodiments.

FIG. 8 is a schematic side view of a fairing that is separating from a rocket and exposing the solar collector system that is at least partially wrapped around the space vehicle, according to some embodiments.

FIG. 9 is a schematic side view of the solar collector system that is at least partially wrapped around the space vehicle, according to some embodiments.

FIG. 10 illustrates a portion of a reflective solar collector that includes a membrane, a first spreader bar on a first edge, and a conduit for carrying a heat transfer fluid, according to some embodiments.

FIG. 11 is a flow diagram of a process for operating a solar gasification system, according to some embodiments.

### DETAILED DESCRIPTION

This disclosure describes a solar collector system that is storable and deployable on a space vehicle. Such a system may be used for collecting heat for converting a cryogenic liquid to its gas phase, which may be utilized by various applications on a space vehicle.

In various embodiments, a solar collector system may comprise a reflective solar collector membrane, an attachment to connect portions of the reflective solar collector membrane to a space vehicle, and a winch and tether system on the space vehicle for holding the reflective solar collector membrane in a closed state that wraps around the space vehicle or for holding the reflective solar collector membrane in an open state that corresponds to a parabolic cylindrical shape that is positioned on a single side of the space vehicle. In the closed state, the reflective solar collector membrane may be configured to insulate the space vehicle from solar radiation, as explained below. Herein, the “single side” of the space vehicle refers to the situation where the reflective solar collector membrane in the open state is extended parabolically from a connection on a lateral side of the space vehicle. Thus, for example, when facing the front (or nose) of the space vehicle, the reflective solar collector membrane may be on the left (port) side of the space vehicle in the open state and wrapped around the space vehicle from the left side of the space vehicle to the right (starboard) side in the closed state.

The solar collector system may further comprise multiple flexible ribs embedded in the reflective solar collector membrane to provide resilience to the reflective solar collector membrane. For example, the multiple flexible ribs may be constructed from a superelastic alloy and thus possess the ability to flex and be bent in conjunction with the reflective solar collector membrane. For example, upon release from a closed state (e.g., wrapped around the space vehicle), these ribs, via the winch and tether system, may be sprung open, drawing (e.g., pulling) the reflective solar collector membrane into the parabolic cylinder in the open state.

The system may further comprise a conduit configured to carry a heat transfer fluid that is circulated through a thermal exchange system (e.g., a heat exchanger) onboard the space vehicle. The heat transfer fluid, such as propylene glycol, may absorb solar energy and heat up as it flows through a portion of the conduit that is in the focal line of the parabolically cylindrical reflective solar collector membrane (that is in the open state). In some implementations, there may be one or more additional conduits in the focal line. The thermal exchange system may be configured to heat a cryogenic liquid to a gas phase by harnessing the absorbed solar energy in the heat transfer fluid. In some implementations, telescoping rods may connect the conduit to the attachment that connects portions of the reflective solar collector membrane to the space vehicle. The telescoping rods may be configured to extend during a transition from a closed state to an open state of the reflective solar collector membrane.

In some embodiments, a system for gasifying a cryogenic fluid in a space vehicle using solar energy may include a first storage tank to contain the cryogenic fluid, a second storage tank to contain gas produced from the cryogenic fluid, a heat exchanger, and tubing configured to carry the cryogenic fluid from the first storage tank, through the heat exchanger, and to the second storage tank. The system may also include a reflective solar collector located external to the space vehicle, and a conduit positioned along a focal line of the reflective solar collector and configured for circulating a heat transfer fluid through the heat exchanger. For example, the heat exchanger may be configured to convey heat from the heat transfer fluid to the cryogenic fluid in the tubing. The cryogenic fluid may be hydrogen or oxygen for example, though claimed subject matter is not limited in this respect.

The reflective solar collector may be configured to be in a closed state or an open state. In particular, the reflective solar collector may be wrapped at least partially around the space vehicle in the closed state and, in contrast, the reflective solar collector may be a parabolic cylinder extending from a side of the space vehicle in the open state.

In some implementations, the reflective solar collector may comprise a reflective membrane having a first spreader bar on a first edge, a second spreader bar on a second edge, and a central axis between and in parallel with both the first edge and the second edge. Accordingly, the system may further comprise an attachment to connect the central axis of the reflective membrane to the space vehicle, and a winch and tether system on the space vehicle. The winch and tether system may be configured to place the first spreader bar and the second spreader bar in a first configuration corresponding to the closed state or a second configuration corresponding to the open state.

The reflective solar collector may further comprise multiple flexible ribs embedded in the reflective membrane to provide resilience to the reflective membrane and to connect the first spreader bar and the second spreader bar together via the attachment or to connect each of the first spreader bar and the second spreader bar to the attachment. The multiple flexible ribs may comprise a superelastic alloy that pulls the reflective membrane into the shape of the parabolic cylinder in the open state. In the closed state, the winch and tether system may bend the flexible ribs to a forced radius of curvature that corresponds to the reflective membrane being configured to wrap around and insulate the space vehicle from solar radiation, as explained below.

The solar collector system may involve relatively simple mechanical parts so that it may be considered more reliable and less massive as compared to a liquid-to-gas conversion system that relies on a combustion-or pneumatically driven-pump and burner. The solar collector system may also have relatively low mass, high energy efficiency, and simple manufacturability.

In some embodiments, a method for gasifying a cryogenic fluid in a space vehicle using solar energy may involve collecting solar heat into a heat transfer fluid from a reflective solar collector. The heat transfer fluid may be transported in a conduit that is in a focal region of the reflective solar collector and circulated through a heat exchanger in the space vehicle. Meanwhile, the method may include drawing the cryogenic fluid from a storage tank into the heat exchanger and adjusting a flow rate (of the cryogenic fluid and/or the heat transfer fluid) to allow the heat exchanger to heat the cryogenic fluid using the solar heat in the heat transfer fluid. As a result of the heating, the cryogenic fluid may be phase-changed to a gas, which may exit the heat exchanger and be subsequently collected and stored in one or more accumulator tanks, for example. As mentioned above, the reflective solar collector may be a parabolic cylinder. Accordingly, the focal region may be a focal line of the parabolic cylinder.

In various embodiments of this method, the reflective solar collector may comprise i) a reflective membrane having a first edge, a second edge, and a central axis between and in parallel with both the first edge and the second edge, and ii) a first spreader bar on the first edge and a second spreader bar on the second edge. In these embodiments, the method may further comprise controlling positions of the first and the second spreader bars to form and maintain the reflective membrane in the parabolic cylinder shape or to wrap the reflective membrane at least partially around the space vehicle for storage or for adding insulation to the space vehicle. In some implementations, controlling the positions of the first and the second spreader bars may comprise operating a winch and tether system on the space vehicle. The winch and tether system may be configured to place the first spreader bar and the second spreader bar in i) a first configuration corresponding to the reflective membrane having the parabolic cylinder shape or ii) a second configuration corresponding to the reflective membrane being wrapped at least partially around the space vehicle.

As described below, in some implementations, before its operation, the reflective solar collector may be stowed within a fairing and at least partially wrapped around a fuel tank of the space vehicle during launch of the space vehicle from Earth.

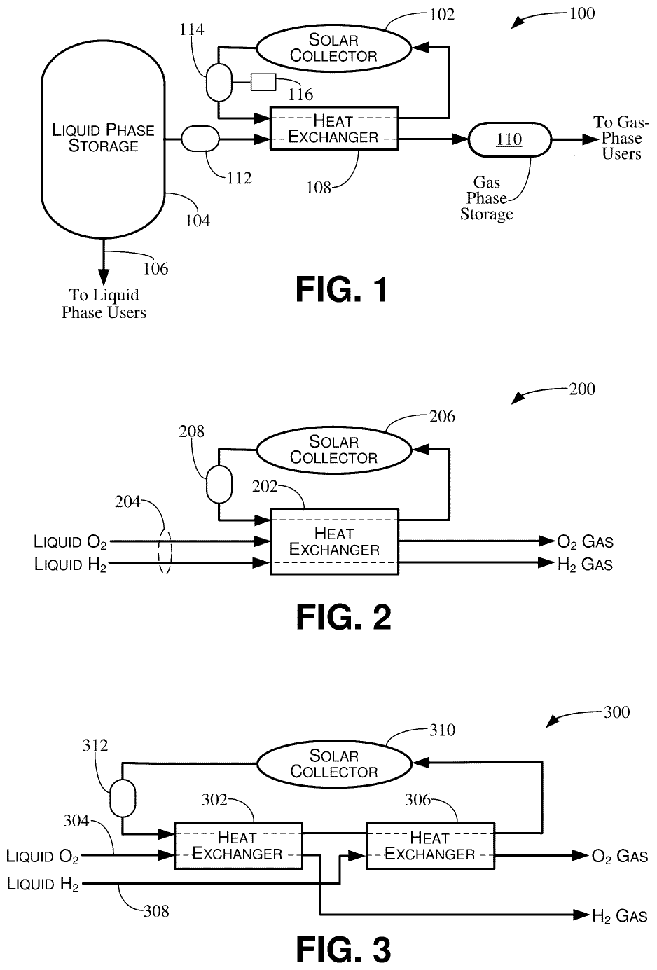

FIG. 1 is a schematic flow diagram of a system 100 for gasifying a cryogenic fluid using solar energy, according to some embodiments. System 100 may be used to convert (e.g., gasify) a cryogenic fluid stored in a space vehicle to a gas that may be subsequently utilized by various systems of the space vehicle. One such system may be a reaction control system (RCS), for example. System 100 may use solar energy collected by a solar collector 102 to facilitate the phase conversion of the cryogenic fluid.

A first storage tank 104 may contain a cryogenic fluid such as liquid oxygen (LO2) or liquid hydrogen (LH2). The stored cryogenic fluid may be provided, on demand, to various users, as indicated by arrow 106, such as propulsion systems, electrical generating systems, or cooling systems, just to name a few examples. The “fluid” may comprise a phase mixture of liquid and gas, which can occur in low-gravity environments. For example, on Earth, where gravity is significant, liquid is generally in a known location within a tank, specifically, settled against the tank's bottom with the gas phase thereabove. In a reduced-gravity environment, however, the absence of a significant gravitational force leads to liquid and gas phases that are generally free to move about inside the tank. In other words, the liquid phase may be “floating” about the tank distant from liquid acquisition output ports (which may be at the “bottom” of the tank). Regardless of whether it is in a pure liquid phase or a mixture of liquid and gas phases, the stored cryogenic fluid may be provided to a heat exchanger 108 of system 100 for gasifying (e.g., eliminating the liquid phase of) the cryogenic fluid.

A second storage tank 110 may be connected at an output of the heat exchanger to contain gas produced from heating the cryogenic fluid. In some implementations, a pump 112 may be used to convey the cryogenic fluid in tubing from the first storage tank, through the heat exchanger, and to the second storage tank.

Solar collector 102 may provide thermal energy (e.g., heat) to heat exchanger 108 to allow for the heating and gasification of the cryogenic fluid that flows through the heat exchanger. In some implementations, a pump 114 may be used to circulate a heat transfer fluid, such as propylene glycol, in tubing from (a focal region of) the solar collector to the heat exchanger. In some implementations, system 100 may include a thermal control system 116 to control the flow of the heat transfer fluid through heat exchanger 108 by selectively operating pump 114. For example, flow may be increased if more heat is needed in the heat exchanger for gasification or flow may be decreased if less heat is needed in the heat exchanger for gasification.

FIG. 2 is a schematic diagram of a heat exchange portion 200 of a solar gasification system, according to some embodiments. For example, system 100 may operate to simultaneously gasify more than one cryogenic fluid. In the present example, a heat exchanger 202 of heat exchange portion 200 may receive, in parallel, both liquid oxygen and liquid hydrogen via conduits 204. A solar collector 206 may provide thermal energy (e.g., heat) to heat exchanger 202 to allow for the heating and gasification of both cryogenic fluids that flow through the heat exchanger. In some implementations, a pump 208 may be used to circulate a heat transfer fluid in tubing from the solar collector to the heat exchanger.

FIG. 3 is a schematic diagram of a heat exchange portion 300 of a solar gasification system, according to some other embodiments. For example, while system 100 may operate to gasify more than one cryogenic fluid, as illustrated in FIG. 2, other heat exchange configurations are possible. In the present example, a first heat exchanger 302 of heat exchange portion 300 may receive liquid oxygen via a conduit 304. Also, a second heat exchanger 306 of heat exchange portion 300 may receive liquid hydrogen via a conduit 308. A solar collector 310 may provide thermal energy (e.g., heat) to both first heat exchanger 302 and second heat exchanger 306 to allow for the heating and gasification of the cryogenic fluids that flow through each of the heat exchangers. In some implementations, a pump 312 may be used to circulate a heat transfer fluid in tubing from the solar collector to the heat exchanger.

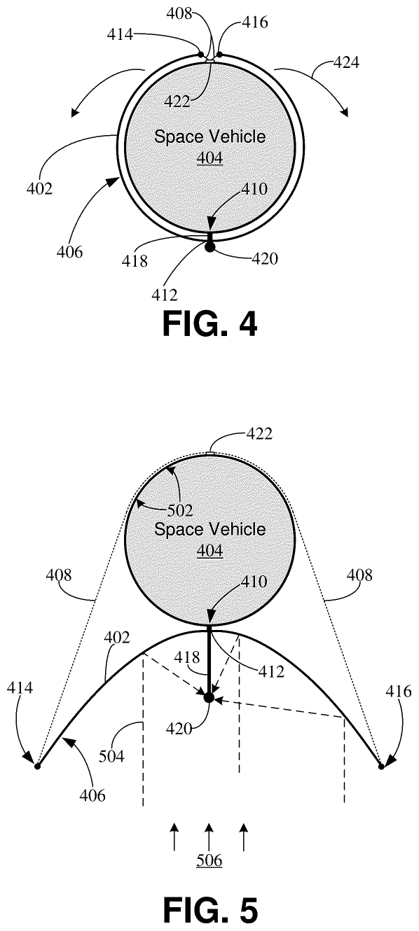

FIG. 4 is a schematic diagram of a reflective solar collector membrane 402 that is undeployed (e.g., a closed state) and wrapped around a space vehicle 404, according to some embodiments. For example, such an undeployed configuration may be selected during a launch of the spacecraft, as explained below, or merely while the reflective solar collector membrane is not being used (e.g., a stored configuration). Also, in space (e.g., in an orbit) the undeployed configuration may be used to insulate the spacecraft against solar radiation. For instance, in the undeployed configuration, the outside surface 406 (e.g., facing away from the space vehicle) of reflective solar collector membrane 402 may be highly reflective to shield space vehicle 404 from a broad spectrum of solar radiation.

As explained below, reflective solar collector membrane 402 may have an intrinsic tendency to form into a parabolic cylinder. In other words, left on its own, without any externally applied forces, reflective solar collector membrane 402 may have the shape of a parabolic cylinder. For example, the reflective solar collector may comprise multiple flexible ribs embedded in a reflective membrane (e.g., Mylar) to provide resilience to the reflective membrane. The multiple flexible ribs may comprise a superelastic alloy that pulls the reflective membrane into the shape of the parabolic cylinder in an open state. In the undeployed configuration illustrated in FIG. 4, however, tethers 408 may retain reflective solar collector membrane 402 in a shape that wraps at least partially around space vehicle 404.

In particular implementations, an attachment 410, which may extend linearly along (e.g., in and out of the page of the figure) an outside surface of space vehicle 404, may connect a central axis 412 of reflective solar collector membrane 402 to the space vehicle. The reflective solar collector membrane may include a first spreader bar 414 on a first edge and a second spreader bar 416 on a second edge of the reflective solar collector membrane. Multiple flexible ribs embedded in the membrane, as mentioned above, may connect the first spreader bar and the second spreader bar together via attachment 410 or may connect each of the first spreader bar and the second spreader bar to the attachment.

At attachment 410, in some implementations, a telescoping conduit support 418 may connect a conduit 420 to attachment 410, as described below. In other implementations, a telescoping conduit support need not be present and instead other techniques may be used to position and support conduit 420. For example, a series of cords (not illustrated) may be attached to parts of reflective solar collector membrane 402, or the spreader bars thereof, and extend to conduit 420. These cords may have particular lengths and may be attached to particular parts of the reflective solar collector membrane so that the conduit is pulled into a focal line of the reflective solar collector membrane as the reflective solar collector membrane is opened to a parabolic cylindrical shape.

A winch system 422 (e.g., a configuration of one or more winches and/or pulleys) on the space vehicle may control the positions of the first and the second spreader bars, and thus the shape of the reflective solar collector membrane, by pulling in or letting out tethers 408. For example, the undeployed configuration illustrated in FIG. 4 may be described as a first configuration wherein the reflective solar collector membrane is maintained in a closed state that wraps around the space vehicle. In the closed state, winch system 422 may draw in tethers 408. In an open state, on the other hand, the winch system may let out tethers 408 so that reflective solar collector membrane 402 may open, as indicated by arrows 424, to a parabolic cylinder, as described below. In some implementations, winch system 422 may be located, as illustrated, on a side of the space vehicle that is opposite the location of attachment 410. In other implementations, winch system 422 may be located on other parts of the space vehicle. Also, the locations of spreader bars 414 and 416 relative to each other and to the space vehicle may be different from that illustrated. Claimed subject matter is not limited in these respects.

FIG. 5 is a schematic diagram of reflective solar collector membrane 402 that is deployed (e.g., an open state) into a parabolic cylinder on a single side of space vehicle 404, according to some embodiments. For example, such a deployed configuration may be used to collect solar radiation to produce heat for a gasification process in a heat exchanger (e.g., 108), as described above. In the deployed configuration, surface 406 of reflective solar collector membrane 402 may be highly reflective to concentrate a broad spectrum of solar radiation onto conduit 420, which may be circulating a heat-transfer liquid from a focal region of the reflective solar collector membrane to the heat exchanger.

As explained above, reflective solar collector membrane 402 may have an intrinsic tendency to form into a parabolic cylinder. Thus, winch system 422 may let out tethers 408 that are connected, respectively, to spreader bars 414 and 416 so that the reflective solar collector membrane can relax into its “natural” shape of a parabolic cylinder. In some implementations, tethers 408 connected between winch system 422 and spreader bars 414 and 416 may slide on outside surface portions 502 of space vehicle 404 due to the juxtaposition between the winch system, the spreader bars, and the space vehicle therebetween.

Accordingly, portions 502 may include rollers, pulleys, or low-friction slides (or merely the outside surface of the space vehicle) that allow tethers 408 to roll or slide against the surface of the space vehicle.

In particular implementations, attachment 410, which may extend linearly along an outside surface of space vehicle 404, may connect central axis 412 of reflective solar collector membrane 402 to the space vehicle. Multiple flexible ribs embedded in the membrane, as mentioned above, may connect first spreader bar 414 and second spreader bar 416 together via attachment 410 (e.g., flexible ribs continuous from the first to the second spreader bar), or may connect each of the first spreader bar and the second spreader bar to the attachment (e.g., flexible ribs only extending from each spreader bar to attachment 410).

At attachment 410, in some implementations, telescoping conduit support 418 may connect conduit 420 to attachment 410 in both the closed state and the open state of the reflective solar collector membrane. For example, as winch system 422 lets out (e.g., extends the length of) tethers 408 connected to the first and the second spreader bars, the reflective solar collector membrane opens and, resultantly, telescoping conduit support 418 may extend so that conduit 420 moves into the focal region of the parabolically cylindrical reflective solar collector membrane.

In an open state, the parabolically cylindrical reflective solar collector membrane 402 may reflect incoming solar radiation toward a focal line of the parabolic cylinder. Conduit 420 may be located at the focal line so that a heat transfer fluid flowing inside the conduit may absorb at least part of this radiation and heat up. This heat may then be transferred to a heat exchanger onboard space vehicle 404, for example. Dashed lines 504 are example ray traces of collimated (due to the large distance from the Sun) solar radiation 506 that is reflected from the reflective solar collector membrane and focused onto conduit 420.

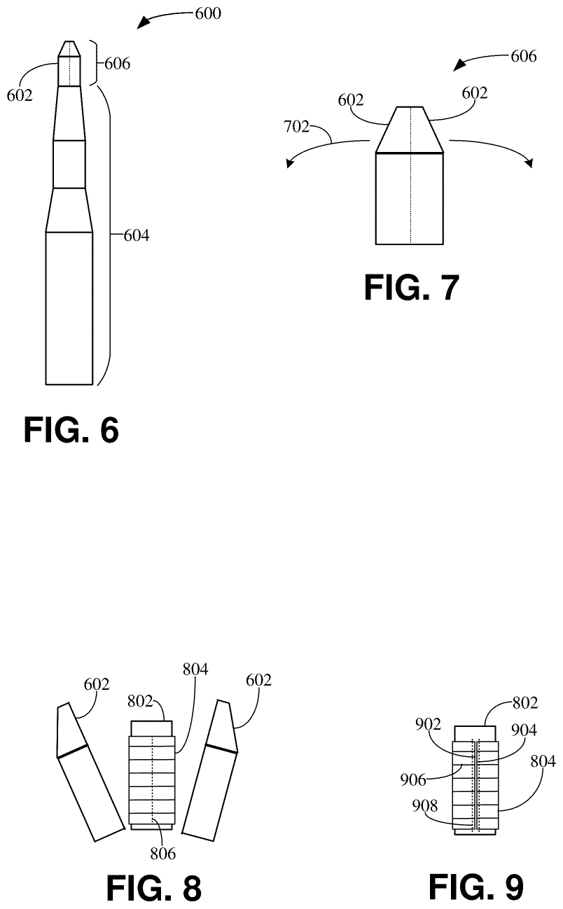

FIG. 6 is a schematic side view of a rocket 600 that includes a fairing 602 that encloses a space vehicle and a solar collector system, according to some embodiments. For example, the space vehicle may be similar to or the same as 404 and the solar collector system may be the same as or similar to 100. Rocket 600 may comprise various propulsion stages 604 with a vehicle/fairing portion 606 being at the top of the rocket. Fairing 602 protects the space vehicle during launch and penetration through Earth's atmosphere. In various implementations, during and after launch, a solar collector system may be at least partially wrapped around the space vehicle in an undeployed configuration (e.g., a closed state). Accordingly, in addition to protecting the space vehicle, fairing 602 also protects the solar collector system.

FIG. 7 is a closeup schematic side view of portion 606 with fairing 602 that encloses the space vehicle and the solar collector system (not illustrated in FIGS. 6 and 7), according to some embodiments. After rocket 600 leaves Earth's atmosphere and arrives into or past a lower orbit, depending on space flight mission details, fairing 602 may separate, as indicated by arrows 702, from portions of rocket 600 that remain after propulsion stages have been removed. Such fairing separation, as illustrated in FIG. 8, exposes a space vehicle 802 and the solar collector system 804 attached thereon, which is at least partially wrapped around the space vehicle in a closed, undeployed state.

For sake of an illustrative example, a side of space vehicle 802 that includes an attachment 806 for the reflective solar collector membrane (e.g., 402) is visible in FIG. 8. As explained above, attachment 806, which is the same as or similar to 410, is a line of connection between space vehicle 802 and the reflective solar collector membrane.

For sake of an illustrative example, a side of space vehicle 802 that includes a winch system (e.g., 422) and spreader bars 902 and 904 (e.g., 414 and 416) pulled relatively close to each other by tethers (e.g., 408) is visible in FIG. 9. The spreader bars being close to each other occurs while the reflective solar collector membrane is in a closed state. FIG. 9 also illustrates multiple flexible ribs 906 that may pull and hold the reflective solar collector membrane into a parabolic cylinder in an open state.

In some implementations, during launch and travel through Earth's atmosphere, and before deployment of the solar collector system 804, a disposable retaining system 908 may temporarily tie first spreader bar 902 and second spreader bar 904 closely together, similar to their relative positioning held by a winch and tether system in a closed state. Such a retaining system may be similar to a zipper-or lace-type of device. The retaining system may be more robust than the winch and tether system in holding the spreader bars together for securing the solar collector system during a launch.

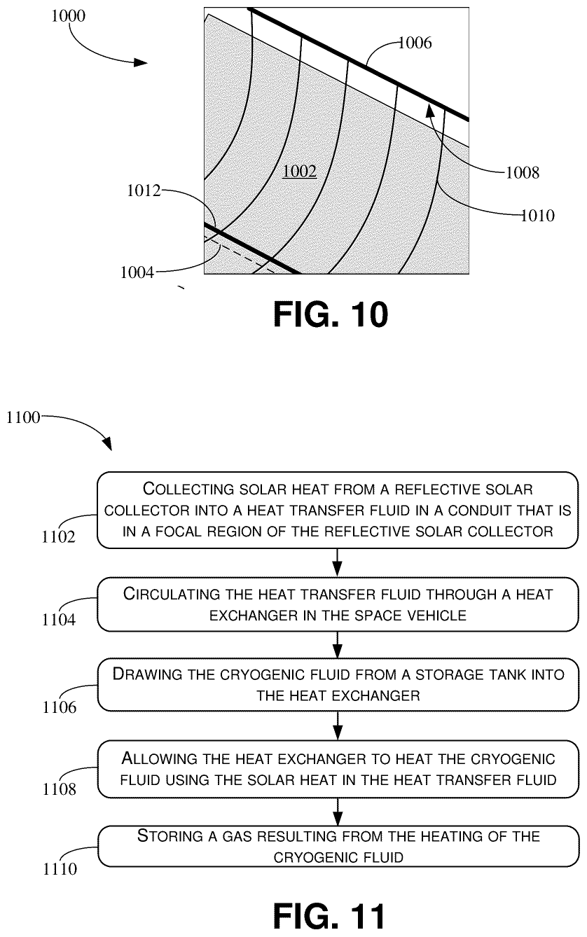

FIG. 10 illustrates a portion 1000 of a reflective solar collector that includes a membrane 1002, an attachment line 1004, a first spreader bar 1006 on a first edge 1008, flexible ribs 1010, and a conduit 1012 for carrying a fluid, according to some embodiments. Membrane 1002 may be made of a flexible reflective material (e.g., Mylar) that is stretched tautly among first spreader bar 1006 and flexible ribs 1010. As explained above, flexible ribs 1010 may be made of a superelastic alloy that pulls membrane 1002 into a parabolic cylinder in an open state when there is no tension (e.g., via tethers 408) on the spreader bars. In contrast, a closed state occurs if a winch system applies tension on the spreader bars by pulling in tethers. When this occurs, flexible ribs will store an elastic restoring force to open the membrane to a parabolic cylinder when the tension on the spreader bars is removed. In some implementations, the flexible ribs may be less than perfect so as to pull membrane 1002 into a less-than-precise parabolic cylinder in the open state when there is no tension on the spreader bars. Accordingly, a winch and tether system may be configured to apply tension on the spreader bars to “fine-tune” the shape of the parabolic cylinder.

Conduit 112, which is configured to carry a fluid that is circulated through a thermal exchange system onboard a space vehicle, may be located in a focal line of the reflective solar collector membrane. As explained above, the fluid may absorb solar energy and heat up as it flows through a portion of the conduit that is in the focal line of the parabolically cylindrical reflective solar collector membrane. In some implementations, telescoping rods (e.g., 418) may connect conduit 1012 to the space vehicle along attachment line 1004, which may correspond to a center axis of the parabolically cylindrical reflective solar collector membrane.

FIG. 11 is a flow diagram of a process 1100 for operating a solar gasification system, such as 100, according to some embodiments. For example, the process may be performed locally or remotely by an electronic controller, a computer processing system following computer-executable instructions, an operator such as a person on a space vehicle or at a remote control center, or a combination thereof.

At 1102, the operator may collect solar heat from a reflective solar collector into a heat transfer fluid in a conduit that is in a focal region of the reflective solar collector. The reflective solar collector is a parabolic cylinder and the focal region is a focal line of the parabolic cylinder. (A parabola has a focal point, wherein a parabolic cylinder has a focal line). The reflective solar collector and the conduit may be located external to the space vehicle. At 1104, the operator may operate a pump to circulate the heat transfer fluid through a heat exchanger in the space vehicle. At 1106, the operator may draw (e.g., pump) the cryogenic fluid from a storage tank into the heat exchanger. At 1108, the operator may operate a pump and/or valves to control a flow rate of the cryogenic fluid through the heat exchanger so as to allow the heat exchanger to heat the cryogenic fluid using the solar heat in the heat transfer fluid. Such heating may result in the gasification of at least some (if not all) of the cryogenic fluid in the heat exchanger. In some implementations, complete gasification may occur downstream of the heat exchanger, and claimed subject matter is not limited in this respect. At 1110, the operator may store the gas resulting from the heating of the cryogenic fluid.

As explained above, the reflective solar collector may comprise i) a reflective membrane having a first edge, a second edge, and a central axis between and in parallel with both the first edge and the second edge, and ii) a first spreader bar on the first edge and a second spreader bar on the second edge. In some implementations, process 1100 may further include controlling positions of the first and the second spreader bars to form and maintain the reflective membrane in the parabolic cylinder shape or to wrap the reflective membrane at least partially around the space vehicle for storage or for adding insulation to the space vehicle. Controlling the positions of the first and the second spreader bars may involve operating a winch and tether system on the space vehicle. The winch and tether system may be configured to place the first spreader bar and the second spreader bar in i) a first configuration corresponding to the reflective membrane having the parabolic cylinder shape or ii) a second configuration corresponding to the reflective membrane being wrapped at least partially around the space vehicle.

In some implementations, process 1100 may further include, before collecting the solar heat from the reflective solar collector, stowing the reflective solar collector within a fairing wherein the reflective solar collector is at least partially wrapped around the circumference of a propellant tank or other portion of the space vehicle during launch of the space vehicle from Earth. The fairing acts to protect the space vehicle and the reflective solar collector during the launch and travel through Earth's atmosphere. Also, the reflective solar collector wrapped around the circumference of a propellant tank helps to thermally insulate the propellant tank. During these stages, and before deployment of the reflective solar collector, a disposable retaining system may temporarily tie the first and the second spreader bars closely together. Such a retaining system may be similar to a zipper-or lace-type of device.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A solar collector system that is storable and deployable on a space vehicle, the system comprising:
a reflective solar collector membrane having a first edge, a second edge, and a central axis between and in parallel with both the first edge and the second edge;
an attachment to connect the central axis of the reflective solar collector membrane to the space vehicle;
a first spreader bar on the first edge and a second spreader bar on the second edge; and
a winch and tether system on the space vehicle, wherein the winch and tether system is configured to place the first spreader bar and the second spreader bar in i) a first configuration that maintains the reflective solar collector membrane in a closed state that wraps around the space vehicle and ii) a second configuration that maintains the reflective solar collector membrane as a parabolic cylinder in an open state and positioned on a single side of the space vehicle.

2. The system of claim 1, further comprising multiple flexible ribs embedded in the reflective solar collector membrane to provide resilience to the reflective solar collector membrane and to i) connect the first spreader bar and the second spreader bar together via the attachment or ii) connect each of the first spreader bar and the second spreader bar to the attachment.

3. The system of claim 2, wherein the multiple flexible ribs comprise a superelastic alloy that pulls the reflective solar collector membrane into a parabolic cylinder shape in the open state.

4. The system of claim 1, wherein in the closed state, the reflective solar collector membrane is configured to insulate the space vehicle from solar radiation.

5. The system of claim 1, further comprising a conduit configured to carry a fluid to absorb solar energy reflected from the reflective solar collector membrane, wherein the conduit is located at a focal line of the reflective solar collector membrane in the open state.

6. The system of claim 5, wherein the conduit is configured to carry the fluid through a thermal exchange system onboard the space vehicle.

7. The system of claim 6, wherein the thermal exchange system is configured to heat a cryogenic liquid to a gas phase by using the absorbed solar energy in the heat transfer fluid.

8. The system of claim 5, further comprising telescoping rods to connect the conduit to the attachment, wherein the telescoping rods are configured to extend during a transition from the closed state to the open state.

9. A system for gasifying a cryogenic fluid in a space vehicle using solar energy, the system comprising:
a first storage tank to contain the cryogenic fluid;
a second storage tank to contain gas produced from the cryogenic fluid;
a heat exchanger;
tubing configured to carry the cryogenic fluid from the first storage tank, through the heat exchanger, and to the second storage tank;
a reflective solar collector located external to the space vehicle; and
a conduit positioned along a focal line of the reflective solar collector and configured for circulating a heat transfer fluid through the heat exchanger, which is configured to convey heat from the heat transfer fluid to the cryogenic fluid in the tubing.

10. The system of claim 9, wherein the reflective solar collector is configured to be in a closed state or an open state, wherein the reflective solar collector is wrapped at least partially around the space vehicle in the closed state and the reflective solar collector is a parabolic cylinder extending from the space vehicle in the open state.

11. The system of claim 10, wherein the reflective solar collector comprises:
a reflective membrane having a first edge, a second edge, and a central axis between and in parallel with both the first edge and the second edge; and
a first spreader bar on the first edge and a second spreader bar on the second edge, and wherein the system further comprises:
an attachment to connect the central axis of the reflective membrane to the space vehicle; and
a winch and tether system on the space vehicle, wherein the winch and tether system is configured to place the first spreader bar and the second spreader bar in a first configuration corresponding to the closed state or a second configuration corresponding to the open state.

12. The system of claim 11, wherein the reflective solar collector further comprises multiple flexible ribs embedded in the reflective membrane to provide resilience to the reflective membrane and to i) connect the first spreader bar and the second spreader bar together via the attachment or ii) connect each of the first spreader bar and the second spreader bar to the attachment.

13. The system of claim 12, wherein the multiple flexible ribs comprise a superelastic alloy that pulls the reflective membrane into a parabolic cylinder shape in the open state.

14. The system of claim 11, wherein in the closed state, the reflective membrane is configured to insulate the space vehicle from solar radiation.

15. The system of claim 11, further comprising telescoping rods to connect the conduit to the attachment.

16. A method for gasifying a cryogenic fluid in a space vehicle using solar energy, the method comprising:
collecting solar heat from a reflective solar collector into a heat transfer fluid in a conduit that is in a focal region of the reflective solar collector, wherein the reflective solar collector and the conduit are located external to the space vehicle;
circulating the heat transfer fluid through a heat exchanger in the space vehicle;
drawing the cryogenic fluid from a storage tank into the heat exchanger;
allowing the heat exchanger to heat the cryogenic fluid using the solar heat in the heat transfer fluid; and
storing a gas resulting from the heating of the cryogenic fluid.

17. The method of claim 16, wherein the reflective solar collector is a parabolic cylinder and the focal region is a focal line of the parabolic cylinder.

18. The method of claim 17, wherein the reflective solar collector comprises i) a reflective membrane having a first edge, a second edge, and a central axis between and in parallel with both the first edge and the second edge, and ii) a first spreader bar on the first edge and a second spreader bar on the second edge, and
wherein the method further comprises controlling positions of the first and the second spreader bars to form and maintain the reflective membrane in the parabolic cylinder shape or to wrap the reflective membrane at least partially around the space vehicle for storage or for adding insulation to the space vehicle.

19. The method of claim 18, wherein controlling the positions of the first and the second spreader bars comprises operating a winch and tether system on the space vehicle, wherein the winch and tether system is configured to place the first spreader bar and the second spreader bar in i) a first configuration corresponding to the reflective membrane having the parabolic cylinder shape or ii) a second configuration corresponding to the reflective membrane being wrapped at least partially around the space vehicle.

20. The method of claim 16, further comprising, before collecting the solar heat from the reflective solar collector, stowing the reflective solar collector within a fairing and at least partially wrapped around a fuel tank of the space vehicle during launch of the space vehicle from Earth.
